(19) United States
(12) Patent Application Publication
(10) Pub. No.: US 2007/0028438 A1
(43) Pub. Date: Feb. 8, 2007

(54) Hunting structures using die cut sheet material for enhanced concealment

(76) Inventors: Terrence W. Missey, Mangolia, IL (US); Mark Nelan, Peoria, IL (US)

Correspondence Address: CLARK & BRODY, 1090 VERMONT AVENUE, NW, SUITE 250, WASHINGTON, DC, 20005, US

(21) Appl. No.: 11/491,112

(22) Filed: Jul. 24, 2006

Related U.S. Application Data
(60) Provisional application No. 60/701,516, filed on Jul. 22, 2005.

(51) Int. Cl. B23P 13/04

(52) U.S. Cl. 29/558

(57) ABSTRACT

A hunting structure designed to support or conceal a hunter for hunting includes a sheet material having a die cut pattern of openings therein. The sheet material attached to the structure or fabric associated with the structure so as to cover at least a portion of the hunting structure to soften its look and improve concealment.

This application claims priority under 35 USC 119(e) based on provisional application No. 60/701,516, filed on Jul. 22, 2005.

### FIELD OF THE INVENTION

The invention is an improvement in the field of hunting structures, and particularly ground blinds that are used for hunting. More particularly, the invention entails the use of die cut sheet material as part of the exterior of the ground blind to soften its look and improve concealment from game.

### BACKGROUND OF THE INVENTION

Ground blinds have continued to increase in popularity over the last five to seven years with the aging hunter as well as with the hunter who does not have trees to climb or who desires to remain on the ground. Just like so many industries today, baby boomers seem to be affecting the hunting industry. Tree stands allows the hunter to sit high up in a tree typically sixteen to twenty feet above the ground. Ground blinds allow the hunter to remain concealed at ground level.

Up until now, manufacturers have used printed camouflage material to construct the various ground blinds on the market. The majority of camouflage patterns on the market today are three dimensional in design. Although the printed camouflage in the market today lends concealment to the hunter, the pattern often appears harsh to the animal the hunter is attempting to remain concealed from. Deer are known to be color-blind. It is thought that when deer see a ground blind made from camouflaged material, the material will appear hard or in other words the material will appear as a solid clump. This is a result of the camouflage being printed on a flat sheet of fabric, and gives a “hard surface look”. FIG. 1 shows a prior art blind 10 having a plurality of windows 1 and stabilizing lines 3. The blind has the typical camouflage fabric as an exterior for concealment purposes.

Other manufacturers have attempted to soften the appearance of the ground blinds. Ameristep has attached a leafy material to the seams of some of the ground blinds they produce. Another manufacturer, Eastman Outdoors, has a system called the Safari System. The Eastman system allows the hunter to actually drape over their blind a softening system provided the hunter is using an Eastman blind that has the necessary straps the safari system needs to be affixed to the blind. The Eastman system does not use solid or sheet material. Their system is strands of leaf cut material that is draped over the blind. This system can be affixed to any blind on the market. However, it will not work as well as it will when used with an Eastman blind that contains the necessary straps needed for the system.

As such, a need exists for improved hunting structures, and particularly ones that do not provide a harsh look as part of the concealment. In response to this need, the present invention provides an improved hunting structure through the use of die cut sheet material as part of the exterior of the hunting structure.

### SUMMARY OF THE INVENTION

The invention entails in one preferred mode ground blind designs using printed camouflage two-dimensional sheet material that has been altered by cutting irregular or regular uniformed lines or openings in the material. The industry term for this material that has cuts in it is die cut.

The die cut sheet material can be cut to the existing shape of the blind. The material can be permanently attached using thread at the existing perimeter seams of the blinds the material is to be attached to. One preferred mode is to attach the die cut material permanently to the exiting blind design. In addition to being attached to the seams in the existing blind, the die cut material can be affixed to the perimeter border of all the openings in the blind. The openings will be for the door and all windows/portholes placed in the blind.

Although one mode entails the manufacture of ground blinds with permanently attached die cut material, another embodiment includes offering a die cut hunting blind cover that may be used with other manufacturers' ground blind designs.

The inventive system and method of use softens the appearance of the entire blind. A given ground blind will use die cut sheet material over the fabric covering of the blind; either another printed camouflaged material or the die cut material may be applied over a solid colored material. No matter what type of material is used for the covering of the ground blind, the camouflaged die cut material when applied over it will soften the appearance of the ground blind giving the user of the blind optimum concealment.

Die cut material is considered to be a sheet or two dimensional fabric material that has a plurality of openings die cut therein, the openings forming a regular or irregular pattern in the fabric material. The openings can cover virtually the entire fabric or be cut into portions of the fabric as is deemed necessary for any given ground blind application. The die cut sheet material can be made of any material capable of having the openings cut into it, and can be made in solid colors or patterns such as camouflage, or combinations thereof.

As noted above, the die cut sheet material can be either permanently or removably attached to a ground blind. Any known attachment means can be employed such as sewing, the use of fasteners such as clips, grommets, etc, adhesives, or a combination of any of the foregoing. When permanently attaching the die cut sheet material to a ground blind, the material can be attached to any component of the ground blind, e.g., the fabric covering of the blind or its frame components or a combination thereof. Preferably, the die cut sheet material is attached at the seams of the fabric covering and at any peripheries of openings in the blind, e.g., windows, portholes or the like. In this mode, the ground blind is manufactured ready for use by a hunter.

In the embodiment wherein the die cut sheet material is removably attachable, again any means to allow for removable attachment can be employed. In this mode, the die cut sheet material could be sold separately for use with one or more ground blinds that are commercially available. Examples of attachment means for removable attachment include hook and loop fasteners, clips, ties, pins, or the like. The attachment means can be located anywhere on the ground blind. In one example, and when using hook and loop fasteners, the hooks could be affixed to the fabric covering with adhesive stitching or fasteners, with the loops being located on the die cut sheet material in the appropriate place to interface with the affixed hooks on the blind to allow for removable attachment.

In the removable attachment mode, the die cut sheet material can be made in different sizes and shape to fit a particular manufacturer's ground blind. The attachment means, if made a part of the die cut sheet material could also be tailored to interface with structure of the manufacturer's design to ease the attachment.

In yet a further embodiment, the die cut sheet material could be draped over the ground blind and secured to the ground rather than the blind itself. In this mode and where the sheet material would not be attached to peripheries of openings in the ground blind, the die cut sheet material would have openings that would align with openings in the ground blind such that when the die cut sheet material is draped over the ground blind, the respective openings align with each other to allow hunters in the ground blind to sight game. In a variation on this embodiment, the die cut sheet material without openings could be draped over a given ground blind and a user of the blind could cut the appropriate openings in the die cut sheet material to align with openings in the fabric covering of the blind. Of course, ground attachment could be combined with attachment to the blind itself if so desired.

Another aspect of the invention involves the use of the die cut material as a shield or personal blind for a hunter when in a treestand or other open hunting structure. The die cut sheet material is shaped in the form of a cape or blanket and attached to the tree of the treestand. The attachment is made at a height so that the personal blind can be draped over the hunter when perched in the tree stand to conceal the hunter. The manner of attachment of the personal blind to the tree can be any type, pins, hooks, staples, straps, or other fasteners. The personal blind can also be attached to the tree with a support so that the personal blind would be spread out for concealment. In this mode, the support extends the personal blind laterally with the hunter positioned behind the cape for concealment purposes. The support can be virtually any type of a support that would allow the personal blind to be spread out, e.g., a bar or member attached to the tree or treestand. The bar could be made in multiple pieces with a pivoting or folding connection between the pieces for easy of transport and/or storage. The personal blind could be attached to the bar or support in any fashion to spread the blind laterally for concealment.

The invention also entails an improved screen window for a hunting structure such as a blind or the like. The screen window is an improvement over the prior art mesh screens that are normally found on hunting blinds and the like. Whereas these prior art screens are made with the screen intact over the entire opening, the inventive screen provides an opening or split in the screen. The opening in the screen allows a hunter situated in the hunting structure to extend the barrel of a firearm through the opening in the screen for hunting purposes, while at the same time allowing an arrow to be shot through the screen as is normally done. The opening can take virtually any form, with one type being either a horizontal or vertical slit in the screen itself or the use of two panels with free ends forming the split, free ends of each segment meeting or overlapping to provide the desired concealment. To form the opening, the hunter can separate the free edges of the segments of the edges of the slit by hand, or merely push the barrel at the free edges or slit. The force of the barrel will cause the separation to allow the barrel to extend beyond the screen for firing. Using two segments with overlapping free edges enhances the concealment since the screen is intact until the edges are separated. This contrasts with just forming a slit in the screen, which may separate over time, and provide less concealment. While either arrangement is acceptable, the use of two screen segments is preferred.

### BRIEF DESCRIPTION OF THE DRAWINGS

FIG. 1 is a perspective view of a prior art hunting blind.

FIG. 2 is a perspective view of one embodiment of the invention as a hunting blind.

FIG. 3 is a perspective view of another embodiment as a treestand.

FIG. 4A is a perspective view of another aspect of the invention wherein the die cut sheet material is used as a personal blind.

FIG. 4B is a side view of another use of the personal blind.

FIG. 5 is a perspective view of yet another embodiment as a shooting house.

FIG. 6 is a perspective view of one embodiment of split screen window.

FIG. 7 is a perspective view of the split screen window of FIG. 6 in use.

### DESCRIPTION OF THE PREFERRED EMBODIMENTS

The present invention offers significant advantages in the field of hunting. The use of the die cut sheet material offers better concealment than the typical camouflage material. Also, the die cut sheet material can be advantageously used in cape form for concealment of a hunter when not enclosed in a hunting structure such as a hunting blind or shooting house. The invention also provides advantages in hunting structures that employ screen windows adapted for bow hunting. The split screen window of the invention allows bow hunting and firearm hunting so that a hunter gains the benefit of the screen window concealment without limitation on the mode of hunting.

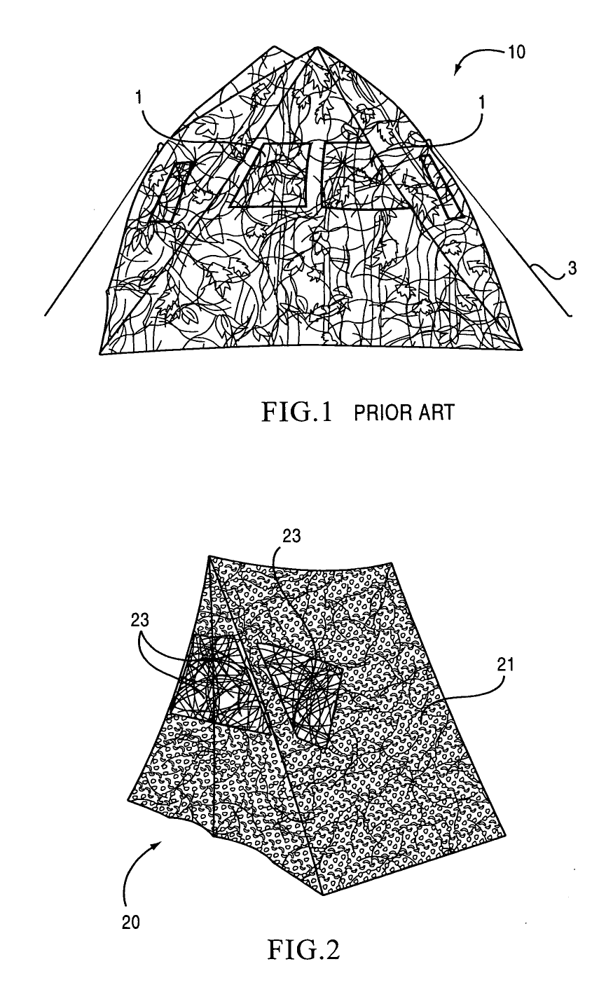

Referring now to FIG. 2, one hunting structure according to the invention is designated by reference 20. The structure 20 shown in FIG. 2 is typically referred to as a blind, and has die cut sheet material 21 covering the exterior of the structure except for windows 23. The die cut sheet material 21 has a camouflage pattern on it. The die cut sheet material 21 is permanently attached to the fabric covering (not shown here but illustrated in FIG. 1) of the ground blind at seams and/or corners and near the peripheries of the blind's openings. As is evident from FIG. 2, the die cut sheet material has a plurality of die cut openings therein, and it attached to the ground blind in such a manner so as not to obscure the windows 23. Of course though, the die cut material could be employed in such a fashion to cover one or more openings in the ground blind, if so desired, and be attached in any way as part of this embodiment. As stated above, the use of the die cut sheet material provides a softer look to the blind, thus improving concealment from game.

Comparing FIGS. 1 and 2 shows that the prior art ground blind without the die cut material is noticeably harsher looking than the blind using the die cut sheet material on its exterior.

In another alternative, the die cut material could replace the typical fabric covering used for a ground blind. Instead of having the die cut material placed over the fabric covering shown in FIG. 1 and attached thereto or attached to the ground, the die cut material could act as the fabric covering and replace the covering show in FIG. 1. That is, the die cut sheet material could be attached to the frame of the ground blind in the same manner as the fabric covering, and with the same type of openings, doors, windows, portals and the like, as found therein. This would reduce costs of the blind by eliminating the fabric covering material entirely.

While the invention is shown in conjunction with a ground blind, other hunting structures could also employ the die cut material, e.g., a tree house or shooting house. In each of these structures, there exists structure or fabric or other types of coverings that can take on a “hard look surface” and therefore need softening.

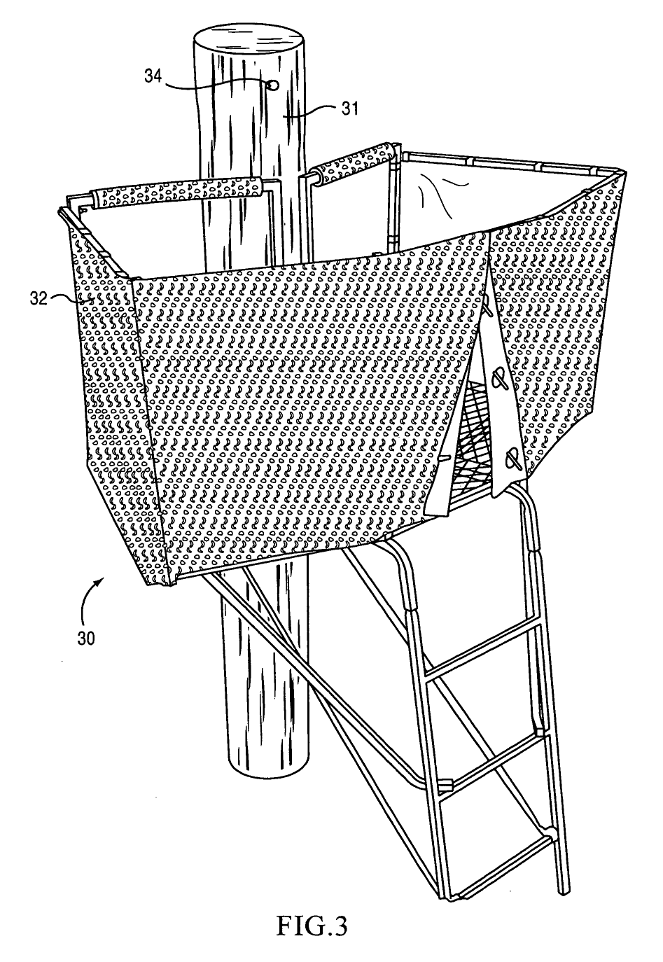

Treestands (fixed position, climbing and ladder) have continued to increase in volume every year. An example of a treestand in shown in FIG. 3, with the treestand designated by the reference numeral 30. With the treestand 30 positioned on a tree 31, the sharp lines and the hunter's silhouette are hard to conceal. To alleviate this problem, it is known to use a treestand skirt to aid in concealment of the treestand, but this fabric covering suffers from the same drawbacks as those used on ground blinds. To improve this problem, the die-cut material can be used over the tree stand skirt to cover the sharp lines of the treestand and/or the tree stand skirt. FIG. 3 shows the die cut sheet material 32 covering the treestand frame, but it should be understood that the die cut sheet material could can be used to cover an existing treestand skirt to allow the hunter to hide his movement and eliminate the hunter's silhouette.

The die cut sheet material can also be employed as a shield or personal blind 35 in connection with the tree stand. Referring to back to FIG. 3, the die cut sheet material personal blind can attached to the tree 30 at a selected height 34. The attachment height 34 should be selected so that sufficient die cut sheet material on either side of the attachment is free from the tree so that it can be draped around a hunter sitting or standing in the tree stand. This provides an added level of concealment by covering the hunter's silhouette.

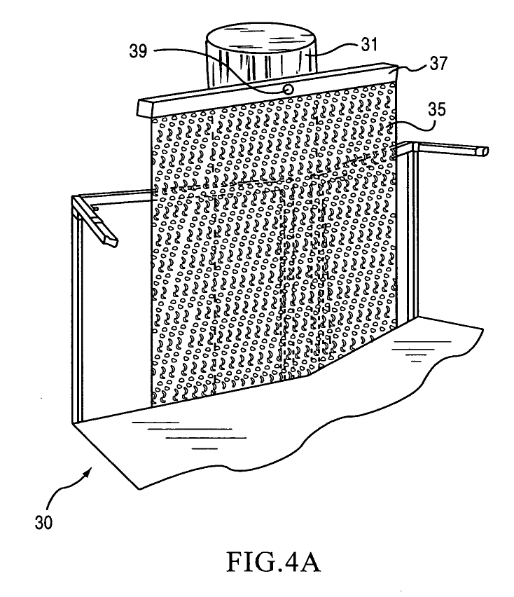

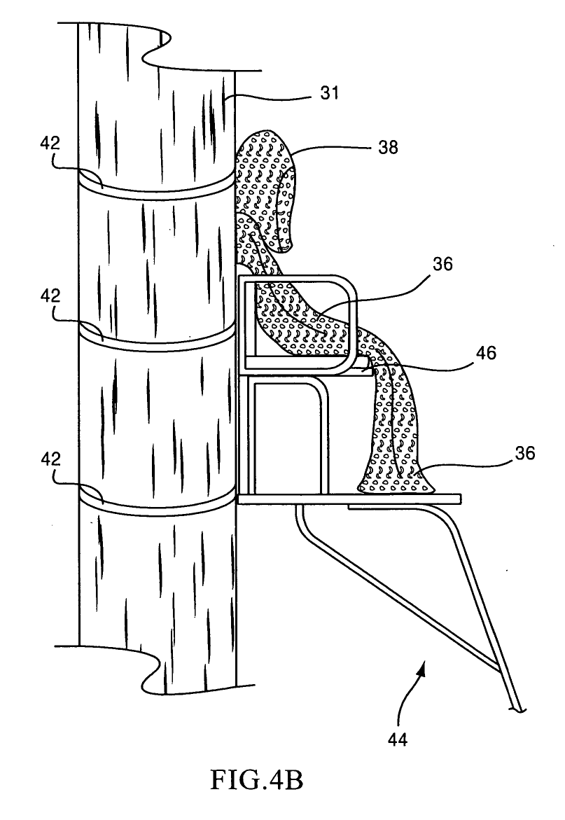

FIG. 4A shows just a portion of the treestand of FIG. 3 and an alternative personal blind mounting arrangement. The personal blind 35 could include a mounting bracket 37 or other mechanical support structure that would attach to the tree and extend beyond the tree as arms for support of the cape rather than using the shoulders or other body portion of a hunter for support. The mounting bracket 37 is shown as a bar attached to the tree at 39, but virtually any type of support could be used to hold the cape for concealment of the hunter in the tree stand. The personal blind 35 is attached to the mounting bracket in any fashion.

In another embodiment, the personal blind can be equipped with one or more straps that are attached to the blind and used to secure the blind to a tree. The straps would be any type that would allow the personal blind to be held at a given location so that a hunter could put the personal blind around his/her body while situated in the tree stand. Also, while the personal blind is shown in a tree stand, it could be used in other hunting structures or environments, where there would be a need to shield a hunter. The personal blind can also have a hood to be draped over a hunter's head when in use. Moreover, the personal blind can have two differently configured sides. One side can be the die cut material with the other side being a black or dark material, or a black or dark surface of the die cut material. The camouflage die cut material can be used as the exterior surface when shielding a hunter in a tree stand or the like. The personal blind can be reversed so that the black or dark side/surface is the exterior surface and this shields the hunter when in an environment also having dark surfaces such as the interior of a ground blind, shooting house or the like. FIG. 4B shows one embodiment of the personal blind designated by the reference numeral 36 with a hood 38. The blind 36 has two straps 42 for attachment to the tree 31. A tree stand 44 is shown schematically with a seat 46. In use, the hunter would sit in the seat 46, wear the hood, and surround himself with the personal blind 36 until ready to shoot a firearm. The hunter could then stand up, shed the blind 36, and to take the shot. Of course, the personal blind 36 could be made without a hood if so desired, and without the dark side if so desired (both sides would look the same).

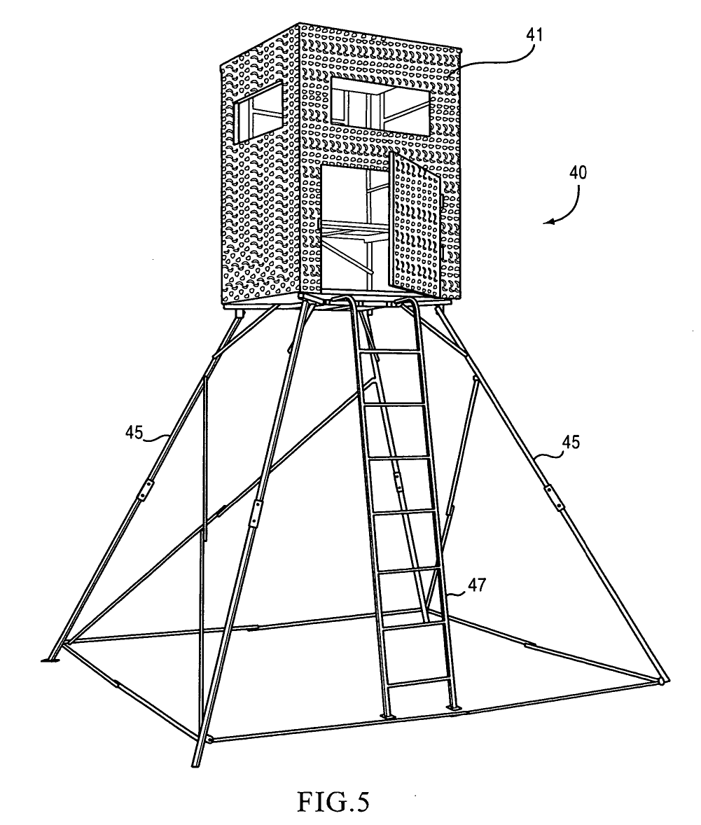

Shooting towers and shooting boxes have continued to increase in popularity over the last 5 to 10 years with the aging hunter as well as with the hunter who does not have trees to climb. The inclement weather also contributes to the successes of the shooting towers and shooting boxes. Most states offer a rifle season and with the bad weather of the north and the lack of trees in the southwest the number of shooting towers and shooting boxes are on the rise. The hard look of the shooting towers made from plastic, steel, or wood still has sharp edges that the corners create. Use of the die-cut material to cover the support legs, walls and/or other features or components of the shooting house will eliminate the hard surface look that the sharp corners, flat surfaces, and other structural components or coverings create. FIG. 5 shows a shooting tower 40, with the tower house 41 covered with the die cut material 43. Although and as stated above, other components such as the support legs and framing 45 and ladder 47 could be covered or shielded in combination with the house or in place thereof.

In either use of the treestand or shooting house, the die cut material can be sized to fit the manufacturer's product, or bought in a larger size and cut to fit the structure being modified, and attached in any known manner.

Thus, the die cut sheet material employed with the ground blind, tree stand, or shooting house can be adapted for use with other hunting structures. That is, any support structure or covering material associated with a hunting structure can employ the sheet of material having the plurality of die cut openings therein. The manner of attachment of the die cut sheet material can vary depending on the particular hunting structure. As with the ground blind, it could be permanently attached to the structure, attached in a removable fashion, or merely draped over the structure and attached to ground or a combination of ground and the structure itself.

The inventive system is affordable and will not dramatically increase the cost of the ground blind.

Specific added values include:

11. Aesthetically appealing to the eye of the consumer.

12. The die cut process increases concealment.

13. The die cut material will blend with the natural surroundings the blind is placed within.

14. Today most ground blind manufacturers encourage their customers to use manufactured synthetic systems or natural sticks/leaves to brush in and conceal the blind. Our system will not require these additional steps decreasing the time to set the blind up while maintaining maximum concealment.

15. The processes described in item four are used to eliminate or at least minimize the hard surface look described above.

16. The inventive system simplifies hunting with a ground blind. It is user friendly and will allow a less experienced hunter or outdoorsman to maximize his chances in the woods.

17. Ground blinds are advertised to be portable. With the pre-manufactured ground blind, once the consumer has it out of its carrying bag and is set up, it is complete.

Another aspect of the invention is the use of an improved screen window on a hunting blind. Normally, an open window on a hunting blind or other structure will not conceal the hunter inside the blind, and the hunter's movement can scare game away from the intended hunting area. To alleviate this problem in certain situations, a mesh screen window, which can also include camouflage pattern on the screen material, is placed over the window of a hunting blind or other hunting structure. This screen window is designed to shield the hunter located in the blind as well as any of the hunter's movement, but still allow the hunter to bow hunt game. The screen window can be attached to the blind in any way, and is designed so that a hunter can shoot an arrow through the screen, particularly a fixed blade broadhead arrow with the screen window intact on the hunting blind. In this way, the shielding of the hunter is maximized, and no interference occurs with the arrow shooting process.

One problem with these prior art screen windows is that they cannot be used when hunting with a firearm. While the projectile of the firearm would easily pass through the screen window, the muzzle blast could ignite the mesh material. Also, keeping the barrel inside the hunting blind contains the noise inside the blind to the hunter's detriment.

The invention provides an improved hunting structure window screen by the presence of a split or opening in the screen. The split is arranged so that when the screen window is in place, the hunter located within the hunting structure is still concealed.

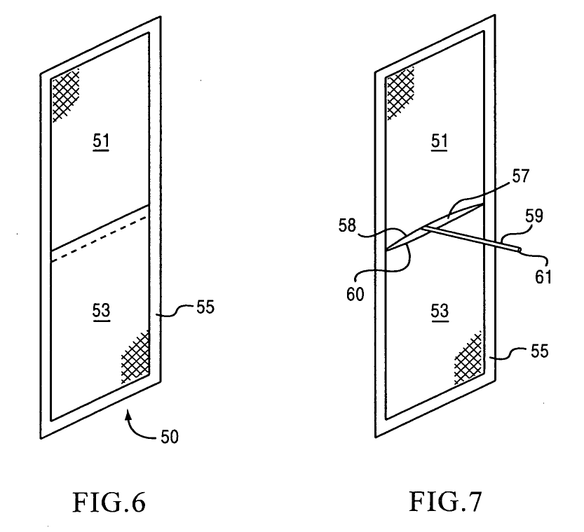

FIGS. 6 and 7 show one example of the inventive screen as reference numeral 50. The screen has two panels 51 and 53, and the panels secured to a frame 55. Although not shown, the frame 55 can be attached to a hunting structure, either permanently such as by stitching or adhesives or removably by hook and loop fasteners, pins, clips or the like. Any other type of attachment can be employed to secure the screen window to cover an opening in a hunting structure. FIG. 7 shows the screen panels separated to form the opening 57, showing free ends 58 and 60. The opening 57 allows the hunter to extend the barrel 59 of a firearm through the opening 57 for hunting purposes and allow the firearm to be fired with the barrel end 61 outside the blind. At the same time, the screen 50 could be used conventionally by shooting an arrow directly through the screen without using the opening 57. Of course, the arrow could also be shot through the opening 57 is so desired. While the screen 50 is shown in rectangular form with a transverse split, the window shape can take any shape and the split can be of any kind, horizontal, vertical, oblique, and the like. Also, the screen 50 could be a one piece screen with an opening therein to allow for barrel penetration. The opening could be a slit that would maintain the concealment ability of the screen while still allowing the barrel of a firearm to extend outside the window for firing. Other types of openings can also be employed providing they do not compromise the shielding effect of the screen.

While not shown, the screen 50 can include a camouflage pattern, and can be made of the same material and mesh size as the one piece prior art screens.

As such, an invention has been disclosed in terms of preferred embodiments thereof which fulfills each and every one of the objects of the present invention as set forth above and provides new and improved hunting structures and components and methods of use.

Of course, various changes, modifications and alterations from the teachings of the present invention may be contemplated by those skilled in the art without departing from the intended spirit and scope thereof. It is intended that the present invention only be limited by the terms of the appended claims.

We claim:

1. In a ground blind having a fabric covering, the improvement comprising covering a portion or the entirety of an exterior of the fabric covering with a sheet material having a die cut pattern of openings therein or forming the fabric covering from a sheet material having a die cut pattern of openings therein.

2. The ground blind of claim 1, wherein the sheet material is either permanently attached or removably attached to a component of the ground blind or is draped over the ground blind and at least secured to ground.

3. The ground blind of claim 2, wherein the removable or permanent attachment is by any means, such as sewing, fasteners, adhesives or a combination thereof.

4. The ground blind of claim 2, wherein the component of the ground blind is the fabric covering or a support structure of the ground blind.

5. The ground blind of claim 1, wherein the sheet material is removably or permanently attached to one or more of seams contained in the fabric covering or peripheries of openings in the fabric covering of the ground blind.

6. The ground blind of claim 1, wherein the fabric covering is a solid color or has a camouflage pattern on it and/or the die cut sheet material is a solid color or has a camouflage pattern on it.

7. A method of softening the look of a ground blind comprising the steps of:
a) providing a ground blind having a fabric covering or ground blind support structure, the fabric covering having one or more openings therein; and
b) covering at least a portion of the fabric covering or the ground blind support structure with a sheet material having a plurality of die cut openings therein to soften the look of the fabric covering or ground blind support structure.

8. The method of claim 7, wherein the die cut sheet material is either permanently or removably attached to the ground blind.

9. The method of claim 7, wherein the die cut sheet material is draped over the fabric covering, and at least secured to ground.

10. In a hunting structure designed to support or conceal a hunter for hunting, the improvement comprising a sheet material having a die cut pattern of openings therein, the sheet material attached to the structure or fabric covering associated with the structure so as to cover at least a portion of the hunting structure to soften its look and improve concealment.

11. The hunting structure of claim 12, wherein the structure is a shooting house supported by legs or walls, the sheet material concealing at least a portion of one or more of the shooting house, the legs or the walls.

14. The hunting structure of claim 12, wherein the structure is a treestand, the sheet material covering at least a portion of the tree stand, or covering at least a portion of a fabric covering associated with the treestand for concealing parts of the tree stand.

15. The hunting structure of claim 12, wherein the hunting structure is a ground blind.
